(19) United States
(12) Patent Application Publication
(10) Pub. No.: US 2015/0332853 A1
(43) Pub. Date: Nov. 19, 2015

(54) METHOD FOR MANUFACTURING CERAMIC ELECTRONIC COMPONENT

(71) Applicant: Murata Manufacturing Co., Ltd., Nagaokakyo-shi (JP)

(72) Inventors: Tomohiro Kageyama, Nagaokakyo-shi (JP); Tetsuo Kawakami, Nagaokakyo-shi (JP); Tsutomu Tanaka, Nagaokakyo-shi (JP); Kenichi Shimazaki, Nagaokakyo-shi (JP); Takahiro Hirao, Nagaokakyo-shi (JP)

(21) Appl. No.: 14/705,058

(22) Filed: May 6, 2015

(30) Foreign Application Priority Data
May 13, 2014 (JP) 2014-099708

(51) Int. Cl. H01G 4/30; H01G 4/012; H01G 4/12

(52) U.S. Cl. CPC H01G 4/30; H01G 4/12; H01G 4/012

(57) ABSTRACT

A method for manufacturing a ceramic electronic component by forming a dielectric layer by ejecting a dielectric layer ink having a pigment volume concentration of 60% or more and 95% or less with an ink-jet system, forming a conductor layer by ejecting a metal pigment ink having a pigment volume concentration of 70% or more and 95% or less with the ink-jet system, forming a body having a conductor circuit by combining the formed dielectric layer and the formed conductor layer appropriately, removing organic components of the resulting formed body by degreasing, and sintering the dielectric layer and the conductor layer by firing.

### BACKGROUND OF THE INVENTION

1. Field of the Invention

The present invention relates to a method for manufacturing a ceramic electronic component. In particular, the present invention relates to a method for manufacturing a ceramic electronic component, for example, a monolithic ceramic capacitor.

2. Description of the Related Art

For example, a monolithic ceramic capacitor, which is one of representatives of ceramic electronic components, is usually configured to include a ceramic element assembly having a structure, in which a plurality of inner electrodes are disposed opposing to each other with dielectric layers therebetween and are led to opposite end surfaces alternately, and outer electrodes disposed on both end sides of the ceramic element assembly in such a way as to be connected to the inner electrodes.

As for a method for manufacturing the above-described monolithic ceramic capacitor, a method for manufacturing a monolithic ceramic capacitor has been disclosed, in which inner electrodes and outer electrodes of a monolithic ceramic capacitor are formed at the same time by ink-jet system printing, so that an occurrence of poor contact between the inner electrode and the outer electrode is suppressed and a step is shortened (refer to, for example, Japanese Unexamined Patent Application Publication No. 2006-270047).

However, the condition of the material contained in a dielectric layer ink or each of an outer electrode ink and an inner electrode ink, which are metal pigment inks, used for the method for manufacturing a monolithic ceramic capacitor described in Japanese Unexamined Patent Application Publication No. 2006-270047 is not limited. Therefore, in order to suppress structural defects during degreasing, the greasing time may be increased. One of main factors of structural defects during degreasing is considered to be a stress based on mismatch of shrinkage timing between the dielectric layer and the inner electrode. In addition, there is a problem that as the resin component increases, a dimensional change during degreasing increases and a stress is generated easily.

### SUMMARY OF THE INVENTION

Accordingly, it is a main object of the present invention to provide a method for manufacturing a ceramic electronic component, wherein occurrences of structural defects can be suppressed in a ceramic electronic component production process by using an ink-jet system and, as a result highly reliable ceramic electronic component can be produced.

A method for manufacturing a ceramic electronic component, according to preferred embodiments of the present invention, includes the steps of forming a dielectric layer by ejecting a dielectric layer ink having a pigment volume concentration of the solid component in the ink (hereafter simply referred to as “pigment volume concentration”) of about 60% or more and about 95% or less with an ink-jet system, forming a conductor layer by ejecting a metal pigment ink having a pigment volume concentration of about 70% or more and about 95% or less with an ink-jet system, forming a formed body having a conductor circuit by combining the forming step of the dielectric layer and the forming step of the conductor layer appropriately, removing organic components of the resulting formed body by degreasing, and sintering the dielectric layer and the conductor layer by firing.

In this regard, in the method for manufacturing a ceramic electronic component, according to preferred embodiments of the present invention, preferably, a single piece of the formed body or a plurality of pieces of the formed body is produced at the same time.

In addition, in the method for manufacturing a ceramic electronic component, according to preferred embodiments of the present invention, the solid concentration of the dielectric layer ink is preferably about 10 percent by volume or more and about 27 percent by volume or less.

Also, in the method for manufacturing a ceramic electronic component, according to preferred embodiments of the present invention, the solid concentration of the metal pigment ink is preferably about 9 percent by volume or more and about 20.5 percent by volume or less.

In addition, in the method for manufacturing a ceramic electronic component, according to preferred embodiments of the present invention, preferably, the solid concentration of the dielectric layer ink or the metal pigment ink is increased as the forming thickness of the dielectric layer or the conductor layer increases.

According to preferred embodiments of the present invention, in the method for manufacturing a ceramic electronic component, the dielectric layer is formed by ejecting a dielectric layer ink having a pigment volume concentration (PVC) of about 60% or more and about 95% or less with an ink-jet system and the conductor layer is formed by ejecting a metal pigment ink having a pigment volume concentration (PVC) of about 70% or more and about 95% or less with an ink-jet system. Therefore, an occurrence of shrinkage mismatch between the dielectric layer and the inner electrode during degreasing can be suppressed, so that the degreasing time can be reduced.

In the method for manufacturing a ceramic electronic component, according to preferred embodiments of the present invention, in the case where the formed body is produced by subjecting a single piece or a plurality of pieces to forming at the same time, a monolithic ceramic capacitor can be produced without including a step to cut a mother multilayer body, which is performed in the manufacturing process of the monolithic ceramic capacitor in the related art.

In the method for manufacturing a ceramic electronic component, according to preferred embodiments of the present invention, in the case where the solid concentration of the dielectric layer ink is about 10 percent by volume or more and about 27 percent by volume or less, when the dielectric layer ink and the metal pigment ink are overprinted, a structure can be obtained without mixing of the two layers.

In the method for manufacturing a ceramic electronic component, according to preferred embodiments of the present invention, in the case where the solid concentration of the metal pigment ink is about 9 percent by volume or more and about 20.5 percent by volume or less, when the dielectric layer ink and the metal pigment ink are overprinted, a structure can be obtained without mixing of the two layers.

In the method for manufacturing a ceramic electronic component, according to preferred embodiments of the present invention, in the case where the solid concentration of the dielectric layer ink or the metal pigment ink is increased as the forming thickness of the dielectric layer or the conductor layer increases, structural defects due to cracks during firing step can be suppressed. Also, printing can be performed with a large forming thickness by using the dielectric layer ink or the metal pigment ink having a high solid concentration and, thereby, the number of times of recoating can be reduced, so that an increase in cost can be suppressed.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a sectional illustration diagram of a monolithic ceramic capacitor produced by a method for manufacturing a monolithic ceramic capacitor according to an embodiment of the present invention;

FIGS. 2A and 2B are schematic diagrams of a printing apparatus used in a method for manufacturing a monolithic ceramic capacitor according to an embodiment of the present invention, FIG. 2A is a schematic diagram showing a printing step, and FIG. 2B is a schematic diagram showing a drying step;

FIGS. 3A and 3B are schematic sectional views showing steps to produce a lower outer layer portion of a monolithic ceramic capacitor in a method for manufacturing a monolithic ceramic capacitor according to an embodiment of the present invention;

FIGS. 4A to 4D are schematic sectional views showing steps to produce an inner layer portion of a monolithic ceramic capacitor in a method for manufacturing a monolithic ceramic capacitor according to an embodiment of the present invention;

FIGS. 5A to 5D are schematic sectional views showing steps to produce the inner layer portion of the monolithic ceramic capacitor, following the step shown in FIG. 4D;

FIGS. 6A and 6B are schematic sectional views showing steps to produce an upper outer layer portion of a monolithic ceramic capacitor in a method for manufacturing a monolithic ceramic capacitor according to an embodiment of the present invention;

FIG. 7 is a diagram showing the relationships between the PVC and the dimensional change rate between before and after degreasing of a dielectric layer ink and a metal pigment ink (inner electrode ink and outer electrode ink);

FIG. 8 is a diagram showing changes in dry body filling factors of a dielectric layer and a conductor layer relative to changes in the PVCs in a dielectric layer ink and a metal pigment ink (inner electrode ink and outer electrode ink); and

FIG. 9 is a diagram showing measurement results of dielectric layer inks and a metal pigment ink (inner electrode ink and outer electrode ink) based on TG-DTA.

### DETAILED DESCRIPTION OF THE PREFERRED EMBODIMENTS

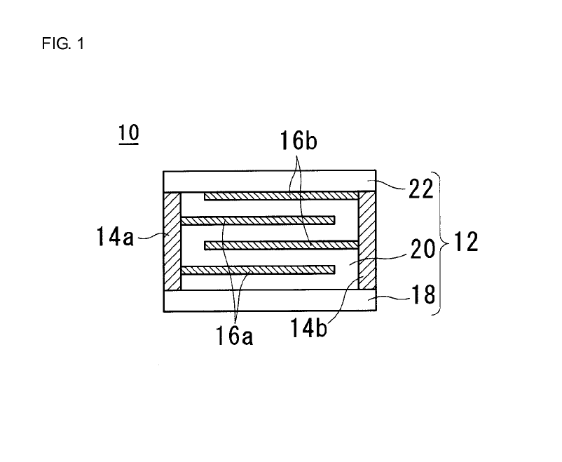

FIG. 1 is a sectional illustration diagram of an example of a monolithic ceramic capacitor produced by a method for manufacturing a monolithic ceramic capacitor according to an embodiment of the present invention.

A monolithic ceramic capacitor 10 is formed into a substantially rectangular parallelepiped shape and includes a dielectric layer 12, outer electrodes 14a and 14b, and inner electrodes 16a and 16b.

The monolithic ceramic capacitor 10 includes dielectric layers 12 made from, for example, barium titanate based dielectric ceramic as the dielectric. The outer electrode 14a is disposed on one end surface of the monolithic ceramic capacitor 10. Likewise, the outer electrode 14b is disposed on the other end surface of the monolithic ceramic capacitor 10.

The dielectric layers 12 is composed of a lower outer layer portion 18, an inner layer portion 20, and an upper outer layer portion 22. In the inner layer portion 20, a plurality of inner dielectric layers and the inner electrodes 16a and 16b arranged alternately at the interfaces between the plurality of inner dielectric layers are disposed. In this case, the inner electrode 16a is disposed in such a way that one end portion is extended to one end portion of the monolithic ceramic capacitor 10 and is electrically connected to the outer electrode 14a, and the inner electrode 16b is disposed in such a way that one end portion is extended to the other end portion of the monolithic ceramic capacitor 10 and is electrically connected to the outer electrode 14b. The lower outer layer portion 18 is arranged under the inner layer portion 20, and the upper outer layer portion 22 is arranged on the inner layer portion 20.

As for the material for the outer electrodes 14a and 14b and the inner electrodes 16a and 16b, Ni, Fe, Al, Ag, W, C, and the like may be used. Plating films are disposed on the surfaces of the outer electrodes 14a and 14b, as necessary.

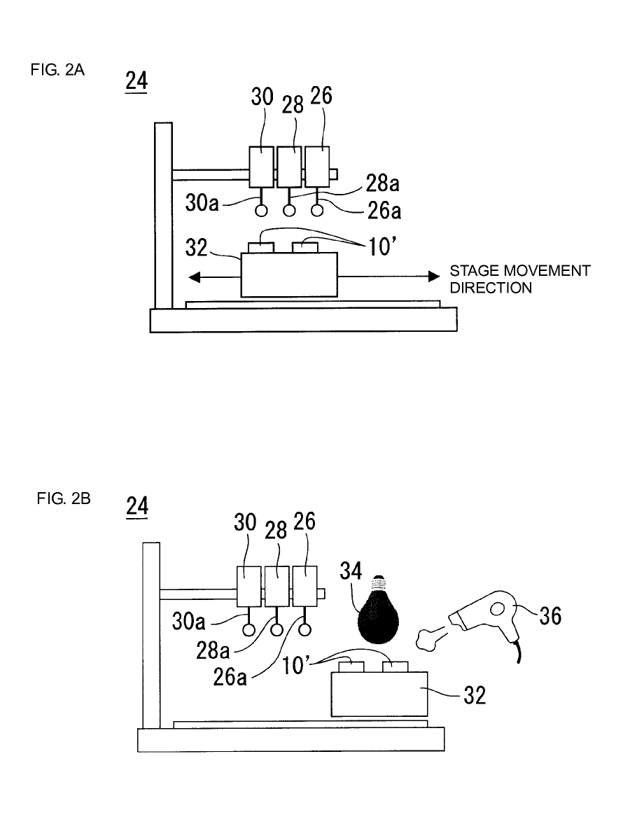

An embodiment of the method for manufacturing a monolithic ceramic capacitor, having the above-described configuration, will be described below. FIGS. 2A and 2B are schematic diagrams of a printing apparatus 24 used in this method for manufacturing a monolithic ceramic capacitor, FIG. 2A is a schematic diagram showing a printing step, and FIG. 2B is a schematic diagram showing a drying step.

The printing apparatus 24 includes a dielectric layer ink-jet head 26, an inner electrode ink-jet head 28, and an outer electrode ink-jet head 30. Also, the printing apparatus 24 includes a stage 32 to produce the dielectric layer 12, the outer electrodes 14a and 14b, and the inner electrodes 16a and 16b of the monolithic ceramic capacitor 10 by printing. The stage 32 is disposed in such a way as to be able to move in the horizontal direction. A ceramic electronic component 10′ before degreasing and firing is obtained with the printing apparatus 24. A dielectric layer ink 26a ejected from the dielectric layer ink-jet head 26 with an ink-jet system, an inner electrode ink 28a ejected from the inner electrode ink-jet head 28 with the ink-jet system, and an outer electrode ink 30a ejected from the outer electrode ink-jet head 30 with the ink-jet system will be described later in detail.

The speed of an ink droplet ejected from each ink-jet head is set at preferably about 6 m/s, for example. In the case where the ejection speed of ink droplet is small, there is a problem that the accuracy of printing position is reduced.

The ejection distance of ink, that is, the distance from the bottom of each ink-jet head to the surface of a printed matter which is an object of printing is preferably about 0.5 mm or less. In the case where the ejection distance of ink is large, there is a problem that the accuracy of printing position is reduced.

The temperature of each ink-jet head is set at preferably about 25° C. If the temperature of each ink-jet head is higher than about 35° C., poor ejection of ink of each ink-jet head becomes considerable.

The movement speed of the stage 32, that is, the printing speed is set at preferably about 100 mm/s.

The temperature of the stage 32 is set at preferably about 60° C. If the temperature of the stage is higher than about 80° C., poor ejection of ink of each ink-jet head becomes considerable.

The condition of drying after printing by each ink-jet head is as described below.

The drying time is preferably about 3 minutes. On the other hand, in the case where the drying time is set at about 1.5 minutes, problems occur because of remaining of a solvent.

In the case where a lamp drier 34 is used as the drying apparatus, a near infrared lamp may be used. At this time, the height of the lamp is set at a distance of about 50 mm from the surface of the printed matter.

An air blow drier 36 may also be used as the drying apparatus.

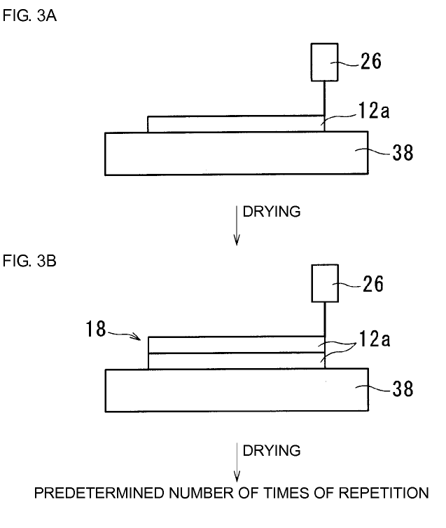

Next, the method for manufacturing a monolithic ceramic capacitor by using the printing apparatus 24 will be described. FIG. 3A to FIG. 6D are diagrams showing production steps by the method for manufacturing a monolithic ceramic capacitor according to an embodiment of the present invention.

Production steps of the lower outer layer portion 18 of the monolithic ceramic capacitor 10 will be described. As shown in FIG. 3A, the dielectric layer ink 26a is printed on a base material 38 to form a dielectric layer 12a. The dielectric layer ink is ejected from the dielectric layer ink-jet head 26 and this is dried. As shown in FIG. 3B, the dielectric layer ink is further printed thereon to form a lower outer layer portion dielectric layer 12a, and drying is further performed. The steps described in FIG. 3A and FIG. 3B are repeated a predetermined number of times. Consequently, the lower outer layer portion 18 of the monolithic ceramic capacitor 10 is formed.

Production steps of the inner layer portion 20 of the monolithic ceramic capacitor 10 will be described.

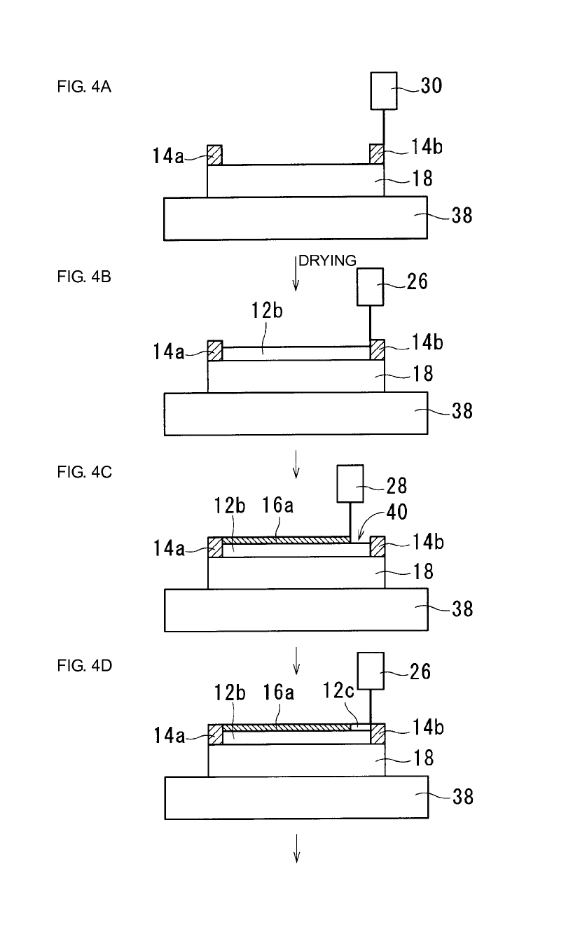

As shown in FIG. 4A, the outer electrode ink 30a is printed on both end portions of the surface of the lower outer layer portion 18 to form the outer electrodes 14a and 14b. The outer electrode ink is ejected from the outer electrode ink-jet head 30. As shown in FIG. 4B, the dielectric layer ink is printed on the surface of the lower outer layer portion 18 and between the outer electrodes 14a and 14b to form an inner dielectric layer 12b, and drying is performed.

As shown in FIG. 4C, the inner electrode ink 28a is printed from the outer electrode 14a toward the outer electrode 14b side on the surface of the inner dielectric layer 12b to form the inner electrode 16a. The inner electrode ink 28a is ejected from the inner electrode ink-jet head 28. At this time, printing is performed in such a way that one end of the inner electrode 16a is electrically connected to the outer electrode 14a. On the other hand, a gap 40 is disposed between the other end of the inner electrode 16a and the outer electrode 14b. As shown in FIG. 4D, an inner dielectric layer 12c is formed in the gap 40 on the surface of the lower outer layer portion 18, and drying is performed.

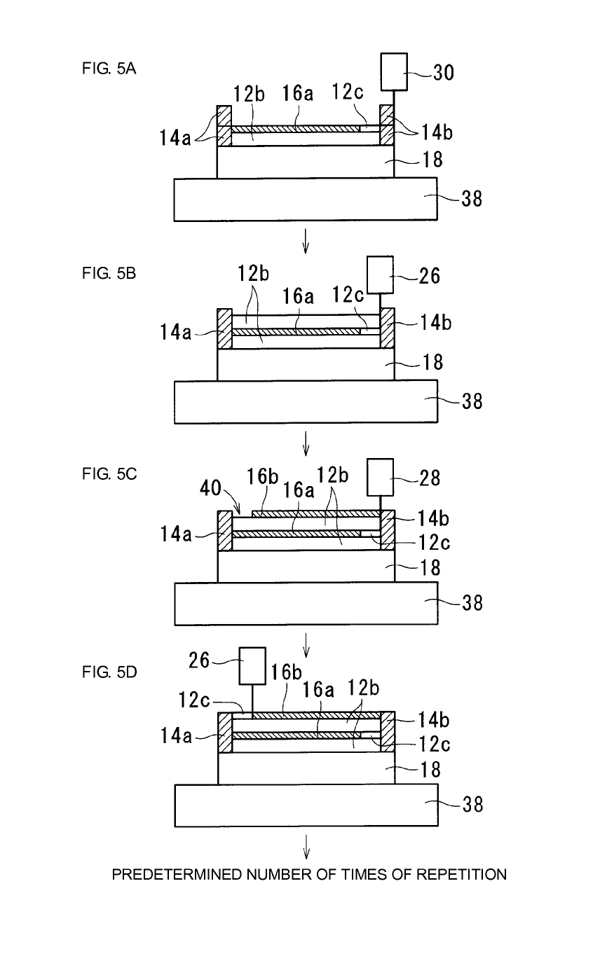

In addition, as shown in FIG. 5A, the outer electrode ink 30a is printed on the surfaces of the outer electrodes 14a and 14b to further form outer electrodes 14a and 14b. As shown in FIG. 5B, the dielectric layer ink is printed on the surfaces of the inner electrode 16a and the inner dielectric layer 12c and between the outer electrodes 14a and 14b to form an inner dielectric layer 12b, and drying is performed.

As shown in FIG. 5C, the inner electrode ink 28a is printed from the outer electrode 14b toward the outer electrode 14a side on the surface of the inner dielectric layer 12b to form the inner electrode 16b. At this time, printing is performed in such a way that one end of the inner electrode 16b is electrically connected to the outer electrode 14b. On the other hand, a gap 40 is disposed between the other end of the inner electrode 16b and the outer electrode 14a. As shown in FIG. 5D, an inner dielectric layer 12c is formed in the gap 40 on the surface of the inner dielectric layer 12b, and drying is performed.

Then, the steps described in FIG. 4A to FIG. 5D are repeated a predetermined number of times. Consequently, the inner dielectric layers 12b and 12c and the inner electrodes 16a and 16b are printed and stacked, so that the inner layer portion 20 is produced.

Next, production of the upper outer layer portion 22 of the monolithic ceramic capacitor 10 will be described.

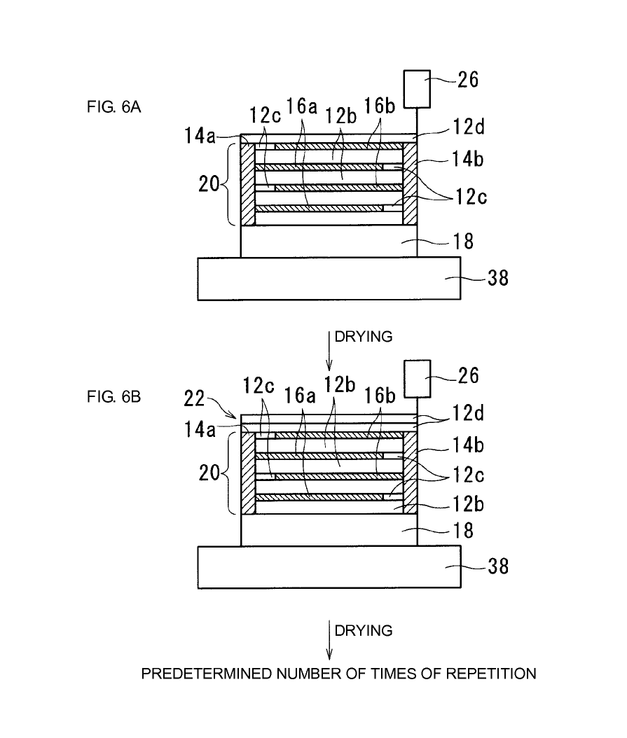

As shown in FIG. 6A, the dielectric layer ink 26a is printed on the surfaces of the inner electrode 16b and the inner dielectric layer 12c to form an upper outer layer portion dielectric layer 12d, and drying is performed. In addition, as shown in FIG. 6B, the dielectric layer ink 26a is printed thereon to form an upper outer layer portion dielectric layer 12d, and drying is further performed. This is repeated a predetermined number of times. Consequently, the upper outer layer portion 22 of the monolithic ceramic capacitor 10 is formed.

The monolithic ceramic capacitor 10′ before degreasing and firing, which is a formed body obtained by the above-described production steps, is subjected to, for example, degreasing to remove organic components at about 280° C. and, in addition, firing is performed at about 1,300° C. to sinter the dielectric layer 12, the inner electrodes 16a and 16b, and the outer electrodes 14a and 14b. Consequently, a predetermined monolithic ceramic capacitor 10 is obtained. in this regard, the degreasing time is, for example, about 13.5 hours.

The dielectric layer ink contains a CaTi,ZrO₃ pigment, a resin, and a solvent. The dielectric layer ink has a pigment volume concentration (PVC), which is a volume proportion of pigment in a solid component in ink, of preferably about 60% or more and about 95% or less. Examples of pigments contained in the dielectric layer ink may include pigments primarily containing SrZrO₃, BaTiO₃, BaTi,CaO₃, and BaTi,ZrO₃ besides the CaTi,ZrO₃ pigment. As for the resin contained in the dielectric layer ink, acrylic resins or PVB resins may be used. It is preferable that the resin contained in the dielectric layer ink be the same type (for example, acrylic resin) as the resin contained in the outer electrode ink and the inner electrode ink, which are metal pigment inks, as described later.

The outer electrode ink and the inner electrode ink are metal pigment inks to form conductor layers, e.g., the outer electrode and the inner electrode, and contain a Ni pigment (metal pigment), CaZrO₃ pigment (common material pigment), a resin, and a solvent. The outer electrode ink and the inner electrode ink have a pigment volume concentration (hereafter referred to as PVC), which is a volume proportion of pigment in a solid component in ink, of preferably about 70% or more and about 95% or less. Examples of pigments contained in the outer electrode ink and the inner electrode ink may include pigments primarily containing Fe, Cu, Al, Ag, W, and C besides the Ni pigment. As for the resin contained in the outer electrode ink and the inner electrode ink, for example, acrylic resins are used.

According to the method for manufacturing a monolithic ceramic capacitor of the present embodiment, the monolithic ceramic capacitor is produced with the ink-jet system and, thereby, each monolithic ceramic capacitor 10 is produced on a piece basis. Therefore, the monolithic ceramic capacitor can be obtained without including a step to cut a mother multilayer body, which is performed in the manufacturing process of the monolithic ceramic capacitor in the related art.

According to the ink-jet system used in the method for manufacturing a monolithic ceramic capacitor of the present embodiment, occurrences of structural defects during degreasing of the monolithic ceramic capacitor are suppressed and the degreasing time can be reduced by specifying the PVC in the dielectric layer ink to be about 60% or more and about 95% or less and specifying the PVC in the outer electrode ink and the inner electrode ink, which are metal pigment inks, to be about 70% or more and about 95% or less.

According to the method for manufacturing a monolithic ceramic capacitor of the present embodiment, the same type of resins are used for the resin contained in the dielectric layer ink and the resin contained in the outer electrode ink or the inner electrode ink and, therefore, occurrences of structural defects of the resulting monolithic ceramic capacitor can be suppressed.

According to the ink-jet system used in the method for manufacturing a monolithic ceramic capacitor of the present embodiment, it is feared that the ink printed on the upper layer side dissolves the lower layer printed by the ink and particles are mixed with each other. In the case where an ink having a solid concentration of about 20 percent by volume or more is used for each of the dielectric layer ink, the outer electrode ink, and the inner electrode ink, the fluidity of each ink is lost immediately after printing and, therefore, a structure in which the dielectric layer and the inner electrode are not mixed at the boundary can be obtained.

In addition, a monolithic ceramic capacitor produced by high PVC inks has low strength and cracking may occur due to stress based on drying shrinkage. However, drying shrinkage is suppressed and a monolithic ceramic capacitor with no cracking during drying can be obtained by using inks each having a solid concentration of about 20 percent by volume or more. In the case where the forming thickness is small, cracking during the drying can be suppressed by reducing the solid concentration to less than 20 percent by volume as well.

On the other hand, preferably, the forming thickness on the basis of printing by the dielectric layer ink is controlled by changing the solid concentration of the dielectric layer ink. For example, in the case where the forming thickness is set at about 1 μm, the solid concentration of the dielectric layer ink is set at about 10 percent by volume, and in the case where the forming thickness is set at about 25 μm, the solid concentration of the dielectric layer ink is set at about 27 percent by volume. In the case where the forming thickness on the basis of printing by the dielectric layer ink is set at about 1 μm, the average particle diameter of the CaTi,ZrO₃ pigment primarily contained in the dielectric layer ink is specified to be preferably about 120 nm, and in the case where the forming thickness is set at about 25 μm, the average particle diameter of the CaTi,ZrO₃ pigment primarily contained in the dielectric layer ink is specified to be preferably about 400 nm.

Preferably, the forming thickness on the basis of printing by the outer electrode ink and the inner electrode ink, which are metal pigment inks, is controlled by changing the solid concentration of the outer electrode ink and the inner electrode ink. For example, in the case where the forming thickness is set at about 1 μm, the solid concentration of the outer electrode ink and the inner electrode ink is set at about 9 percent by volume, and in the case where the forming thickness is set at about 25 μm, the solid concentration of the outer electrode ink and the inner electrode ink is set at about 20.5 percent by volume. In the case where the forming thickness on the basis of printing by the outer electrode ink and the inner electrode ink is set at about 1 μm, preferably, the average particle diameter of the Ni pigment primarily contained in the outer electrode ink and the inner electrode ink, which are metal pigment inks, is specified to be about 300 nm and the average particle diameter of the CaZrO₃ pigment is specified to be about 13 nm, and in the case where the forming thickness is set at about 25 μm, preferably, the average particle diameter of the Ni pigment primarily contained in the outer electrode ink and the inner electrode ink, which are metal pigment inks, is specified to be about 200 nm and the average particle diameter of the CaZrO₃ pigment is specified to be about 200 nm.

In addition, cracking may occur at the interface on the basis of shrinkage mismatch between the dielectric layer and the outer electrode or inner electrode, which are made from metal pigment inks, during firing. In this case, suppression can be performed by increasing the amount of common material of the outer electrode ink or inner electrode ink, which are metal pigment inks. For example, in the case where a thick film (about 5 μm or more) of outer electrode or the like is formed, the common material mixing rate is desirably about 0.77 (weight ratio about 0.4) or more on a volume ratio (volume of common material pigment/volume of metal pigment) in the metal pigment ink basis.

### EXAMPLE

In the example, a monolithic ceramic capacitor 10 was produced by the above-described manufacturing method. The condition was as described below.

That is, the CaTi,ZrO₃ pigment was used as the dielectric layer ink. The average particle diameter of the CaTi,ZrO₃ pigment was specified to be about 400 nm. The PVC in the dielectric layer ink was specified to be about 80%, and the solid concentration was specified to be about 27.0 percent by volume.

The Ni pigment and the CaZrO₃ pigment were used as the inner electrode ink or the outer electrode ink, which was a metal pigment ink. The average particle diameter of the Ni pigment was specified to be about 200 nm and the average particle diameter of the CaZrO₃ pigment was specified to be about 200 nm. The PVC in the metal pigment ink was specified to be about 80%, and the solid concentration was specified to be about 22.0 percent by volume.

As for the outer dimensions of the monolithic ceramic capacitor, a sample (Sample 1) had a length (L) of about 13 mm, a width (W) of about 17 mm, and a height (T) of about 4.0 mm and a sample (Sample 2) had a length (L) of about 8 mm, a width (W) of about 6 mm, and a height (T) of about 4.0 mm. The thickness of the inner dielectric layer after firing was specified to be about 25 μm, and the thickness of the inner electrode after firing was specified to be about 3.5 μm. The number of stacking of the inner electrode was specified to be 118. The thickness of each of the lower outer layer portion and the upper outer layer portion was specified to be about 300 μm. Six samples of each of Sample 1 and Sample 2 were produced.

### COMPARATIVE EXAMPLE

In the comparative example, the condition was specified to be the same as the condition of the example except that the PVC in the dielectric layer ink was specified to be about 60% and the PVC in the metal pigment ink was specified to be about 60%.

In the monolithic ceramic capacitor produced under the condition of the comparative example, a structural defect was generated unless degreasing was performed for about 60 hours or more in the degreasing step, whereas in the monolithic ceramic capacitor produced under the condition of the example, samples in which a structural defect was not generated were able to be obtained on the basis of a 13.5-hour degreasing profile in the degreasing step.

Evaluation of Characteristics

In addition, samples of the monolithic ceramic capacitor were subjected to evaluations (evaluation based on the dimensional change rate, evaluation based on the dry body filling factor, evaluation based on TG-DTA, evaluation based on a change in the amount of common material, and evaluation based on a change in the solid concentration) described below.

Evaluation Based on Dimensional Change Rate

Dimensional changes between before and after degreasing in the case where the PVC in each of the dielectric layer ink and the metal pigment ink was changed were evaluated. The condition of the monolithic ceramic capacitor used for the evaluation was the same as the condition in the example except the PVCs in the dielectric layer ink and the metal pigment ink. As for the monolithic ceramic capacitor used for the evaluation, a single sheet of about 5 mm×about 5 mm×about 1 mm was produced as a model sample and the evaluation was performed.

The dimensional change of the dielectric layer ink was evaluated on the basis of the dimensional change rate of the inner dielectric layer, and the dimensional change of the metal pigment ink was evaluated on the basis of the dimensional change rate of the inner electrode (conductor layer). Calculation was performed individually on the basis of dimensional change rate=√((length L after degreasing×width W after degreasing)/((length L before degreasing×width W before degreasing)). Each dimensional change rate was specified to be an average of five samples.

Presence or absence of structural defect of the resulting monolithic ceramic capacitor was evaluated with respect to the PVC in each of the dielectric layer ink and the metal pigment ink.

Evaluation Based on Dry Body Filling Factor

Changes in the dry body filling factors in the case where the PVC in each of the dielectric layer ink and the metal pigment ink was changed were evaluated. The condition of the monolithic ceramic capacitor used for the evaluation was the same as the condition in the example except the PVCs in the dielectric layer ink and the metal pigment ink. As for the monolithic ceramic capacitor used for the evaluation, a single sheet of about 5 mm×about 5 mm×about 1 mm was produced as a model sample and the evaluation was performed.

Changes in the filling factor of a dry body were determined, where areas of resin and gap portions were determined on the basis of an image, and the ratio of the area determined by subtracting the areas of resin and gap portions from the area of the entire image to the area of the entire image was specified to be the dry body filling factor. As for the condition of the image used for the observation, a cross-section of the above-described single sheet was observed by using FE-SEMS-4800 produced by Hitachi, Ltd., at the magnification of 10,000 times.

Evaluation Based on TG-DTA

Evaluation on the basis of difference between the resin contained in the dielectric layer ink and the resin contained in the metal pigment ink was performed with TG-DTA. The condition of the monolithic ceramic capacitor used for the evaluation was the same as the condition in the example except the PVCs in the dielectric layer ink and the metal pigment ink and the resins contained. As for the monolithic ceramic capacitor used for the evaluation, a single sheet of about 5 mm×about 5 mm×about 1 mm was produced as a model sample and the evaluation was performed.

An acrylic resin and a PVB resin were prepared as the resin contained in the dielectric layer ink and an acrylic resin was prepared as the resin contained in the metal pigment ink (Ni pigment ink). The measurement condition of TG-DTA was as described below. Company name and Model number of apparatus: Thermo Plus TG8120 produced by Rigaku Corporation, sample weight: 150 mg, atmosphere gas: N₂, flow rate of atmosphere gas: 50 cc/min, and temperature raising rate: 3.0° C./min.

Evaluation Based on Change in Amount of Common Material

Evaluation was performed on presence or absence of structural defect generated in the monolithic ceramic capacitor in the case where the amount of common material contained in the metal pigment ink was changed. The condition of the monolithic ceramic capacitor used for the evaluation was the same as the condition in the example except the amount of common material contained in the metal pigment ink. As for the monolithic ceramic capacitor used for the evaluation, a two-layer sheet of about 5 mm×about 5 mm×about 2 mm was produced and the evaluation was performed.

Three patterns of volume ratio (volume of CaZrO₃ pigment/volume of Ni pigment) of the Ni pigment having a PVC of about 80% to the CaZrO₃ pigment having a PVC of about 80% contained in the metal pigment ink of 0 (weight ratio 0), about 0.39 (weight ratio about 0.2), and about 0.77 (weight ratio about 0.4) were prepared.

Evaluation Based on Change in Solid Concentration

In order to evaluate the relationship between the solid concentration and the forming thickness produced by the dielectric layer ink, two types of dielectric layer forming thicknesses of about 1 μm and about 25 μm were produced by the dielectric layer ink. At this time, in the case where the forming thickness of about 1 μm was produced by the dielectric layer ink, the average particle diameter of the CaTi,ZrO₃ pigment contained in the dielectric layer ink was specified to be about 120 nm and a dielectric layer ink having a PVC of about 80% and a solid concentration of about 10 percent by volume was used. In the case where the forming thickness of about 25 μm was produced by the dielectric layer ink, the condition was specified to be the same as the condition in the example.

In order to evaluate the relationship between the solid concentration and the forming thickness produced by the metal pigment ink, two types of conductor layers having forming thicknesses of about 1 μm and about 25 μm were produced by the metal pigment ink. At this time, in the case where the forming thickness of about 1 μm was produced by the metal pigment ink, the average particle diameter of the Ni pigment contained in the metal pigment ink was specified to be about 300 nm, the average particle diameter of the CaZrO₃ pigment was specified to be about 13 nm, and a metal pigment ink having a PVC of about 70% and a solid concentration of about 9.0 percent by volume was used. In the case where the conductor layer having a forming thickness of about 25 μm was produced by the metal pigment ink, the condition was specified to be the same as the condition in the example except that the solid concentration of the metal pigment ink was specified to be about 20.5 percent by volume.

Evaluation Results of Each Characteristic

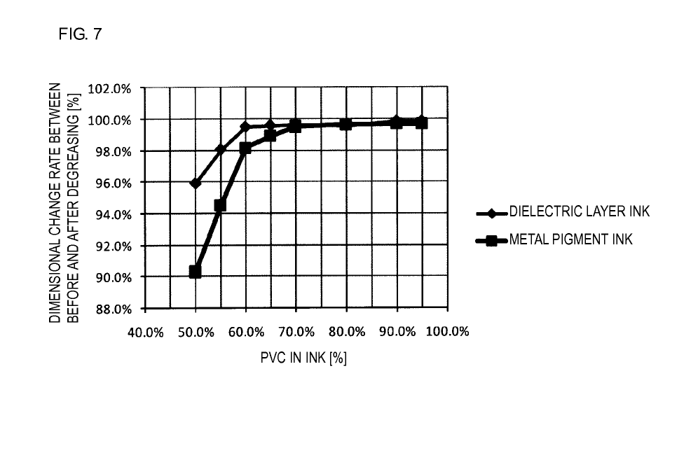

Table 1 shows the values of dimensional change rate of the inner dielectric layer and the dimensional change rate of the inner electrode relative to the PVC in each of the dielectric layer ink and the metal pigment ink (inner electrode ink and outer electrode ink), and FIG. 7 shows the results thereof as a graph.

Table 2 shows the results of examination of presence or absence of structural defect of the produced monolithic ceramic capacitor in the case where the PVCs in the dielectric layer ink and the metal pigment ink (inner electrode ink and outer electrode ink) were changed. In Table 2, the case where a structural defect was generated was indicated by “×”, the case where there was no large structural defect is indicated by “◯”, and the case where there was no structural defect is indicated by “\textcircled{•}”.

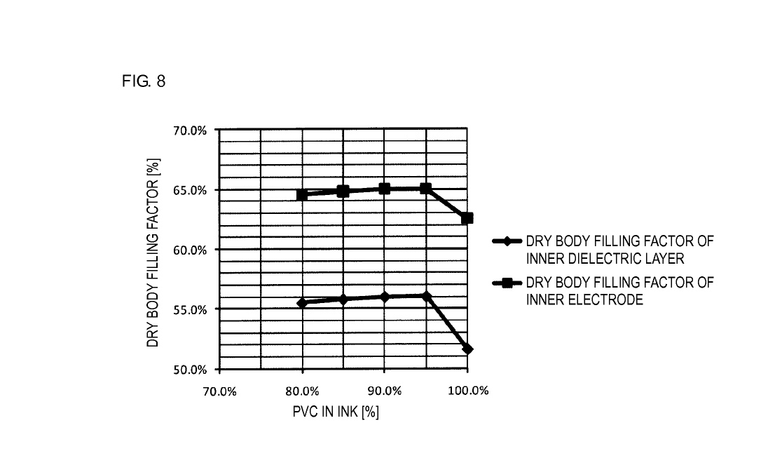

Table 3 shows the dry body filling factor of the inner dielectric layer and the dry body filling factor of the inner electrode in the case where the PVC in the dielectric layer ink or the metal pigment ink (inner electrode ink and outer electrode ink) was changed, and FIG. 8 shows the results thereof as a graph.

TABLE 1

| PVC of dielectric | Dimensional change | Dimensional change |
|---|---|---|
| layer ink or metal | rate of inner | rate of inner |
| pigment ink | dielectric layer | electrode |
| 95.0% | 99.9% | 99.7% |
| 90.0% | 99.9% | 99.7% |
| 80.0% | 99.6% | 99.6% |
| 70.0% | 99.6% | 99.5% |
| 65.0% | 99.6% | 98.9% |
| 60.0% | 99.5% | 98.2% |
| 55.0% | 98.1% | 94.5% |
| 50.0% | 95.9% | 90.3% |

TABLE 2

| | | PVC of dielectric layer ink | | | | | | | | | | |
|---|---|---|---|---|---|---|---|---|---|---|---|---|
| | | 50% | 55% | 60% | 65% | 70% | 75% | 80% | 85% | 90% | 95% | 100% |
| PVC of | 50% | X | X | X | X | X | X | X | X | X | X | X |
| metal | 55% | X | X | X | X | X | X | X | X | X | X | X |
| pigment | 60% | X | X | X | X | X | X | X | X | X | X | X |
| ink | 65% | X | X | X | X | X | X | X | X | X | X | X |
| | 70% | X | X | ◯ | ◯ | ◯ | ◯ | ◯ | ◯ | ◯ | ◯ | X |
| | 75% | X | X | ◯ | ◯ | ◯ | ◯ | ◯ | ◯ | ◯ | ◯ | X |
| | 80% | X | X | ◯ | ◯ | ◯ | [symbol] | [symbol] | [symbol] | [symbol] | [symbol] | X |
| | 85% | X | X | ◯ | ◯ | ◯ | [symbol] | [symbol] | [symbol] | [symbol] | [symbol] | X |
| | 90% | X | X | ◯ | ◯ | ◯ | [symbol] | [symbol] | [symbol] | [symbol] | [symbol] | X |
| | 95% | X | X | ◯ | ◯ | ◯ | [symbol] | [symbol] | [symbol] | [symbol] | [symbol] | X |
| | 100% | X | X | X | X | X | X | X | X | X | X | X |

TABLE 3

| PVC of dielectric | Dry body filling | Dry body filling |
|---|---|---|
| layer ink or metal | factor of inner | factor of inner |
| pigment ink | dielectric layer | electrode |
| 100.0% | 51.6% | 62.5% |
| 95.0% | 56.0% | 65.0% |
| 90.0% | 56.0% | 65.0% |
| 85.0% | 55.8% | 64.8% |
| 80.0% | 55.5% | 64.5% |

Measurement of Dimensional Change Rate, Results Thereof, and Examination of Structural Defect

In the production process of the monolithic ceramic capacitor in the related art, production has been performed in combination of regions where dimensional change of the dielectric layer and the inner electrode (conductor layer) occur (for example, the PVC in the dielectric layer ink is about 50% and the PVC in the metal pigment ink is about 60%). In this case, the structural defects have been suppressed by devising the firing profile in the firing step.

As is clear from Table 1, the dimensional change did not occur easily by increasing the PVC. Specifically, as is clear from Table 1 or FIG. 7, the dimensional change of the dielectric layer ink hardly occurred in the range of PVC of about 60% or more and about 95% or less. Also, the dimensional change of the metal pigment ink hardly occurred in the range of PVC of about 70% or more and about 95% or less.

Therefore, it was indicated that in the case where the PVC in the dielectric layer ink was specified to be about 60% or more and about 95% or less and the PVC in the metal pigment ink was specified to be about 70% or more and about 95% or less, the dimensional change hardly occurred and devising of degreasing profile was not required with respect to the structural defect due to shrinkage mismatch in the degreasing step.

Meanwhile, the structural defect of the produced monolithic ceramic capacitor was examined. As shown in Table 2, in the case where the PVC in the dielectric layer ink was specified to be about 60% or more and about 95% or less and the PVC in the metal pigment ink was specified to be about 70% or more and about 95% or less, a large structural defect was not observed. In addition, in the case where the PVC in the dielectric layer ink was specified to be about 75% or more and about 95% or less and the PVC in the metal pigment ink was specified to be about 80% or more and about 95% or less, no structural defect was observed. Consequently, it was ascertained that PVCs in the inks within these ranges were more preferable.

On the other hand, in the case where the PVC in the dielectric layer ink was specified to be about 50% or more and about 55% or less and the PVC in the metal pigment ink was specified to be about 50% or more and about 65% or less, or in the case where the PVC in the dielectric layer ink and the PVC in the metal pigment ink were specified to be about 100%, a large structural defect was observed in the resulting monolithic ceramic capacitor.

Measurement of Dry Body Filling Factor and Results Thereof

In the case where the dry body filling factor was high, dimensional changes during the entire heat treatment step in the degreasing and firing step were small. As shown in Table 3 or FIG. 8, the dry body filling factor of each of the inner dielectric layer and the inner electrode increased until the PVC in the dielectric layer ink and the PVC in the metal pigment ink reached about 95%.

On the other hand, in the case where the PVC in the dielectric layer ink and the PVC in the metal pigment ink were specified to be about 100%, the dry body filling factor of each of them decreased.

It was indicated from the above-described results that the upper limits of the PVC in the dielectric layer ink and the PVC in the metal pigment ink were preferably about 95%.

Measurement with TG-DTA and Results Thereof

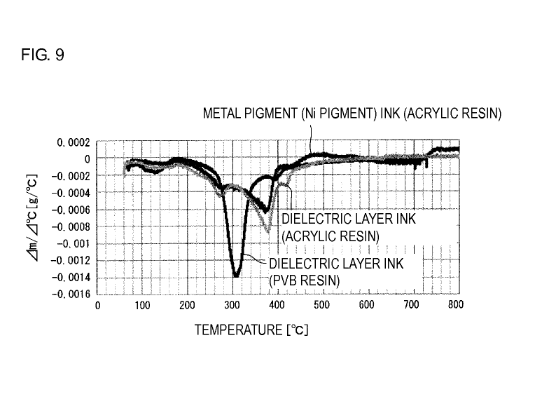

FIG. 9 is a diagram showing the results of measurement of the dielectric layer ink and the metal pigment ink (inner electrode ink and outer electrode ink) with TG-DTA.

In the case where weight reduction temperatures are different between the dielectric layer ink and the metal pigment ink, shrinkage mismatch occurs and causes generation of a structural defect. That is, in the case where the types of resins contained in the dielectric layer ink and the metal pigment ink are different or the compatibility between the resins is poor, adhesion between the dielectric layer and the conductor layer is poor and delamination may occur.

As is clear from FIG. 9, the resin of the dielectric layer ink was switched from the PVB resin to the acrylic resin and, thereby, an ink exhibiting a weight reduction peak in the same temperature region as that of the metal pigment ink by using the acrylic resin was able to be produced. Therefore, it was ascertained that the weight reduction temperatures were made to be substantially equal by specifying the resins contained in the dielectric layer ink and the metal pigment ink to be substantially the same type and, as a result, generation of structural defects was able to be suppressed.

Examination of Presence or Absence of Structural Defect Due to Change in Amount of Common Material

In particular, in the case where the Ni pigment is used as the metal pigment ink for forming of the outer electrode produced by co-firing (firing at the same time), in general, a thick film is formed as compared with the case where a common inner electrode is formed, so that cracks are generated considerably.

It was ascertained that in the case where the volume ratio (volume of CaZrO₃ pigment (common material pigment)/volume of Ni pigment) as the amount of common material contained in the metal pigment ink was 0, the monolithic ceramic capacitor was broken while being bended significantly. Also, it was ascertained that in the case where the volume ratio was about 0.2, a small crack was generated in the dielectric layer.

On the other hand, it was ascertained that in the case where the volume ratio was specified to be about 0.77, no structural defect was generated in the resulting monolithic ceramic capacitor and the common material formed a network structure. Therefore, it was ascertained that in the case where a thick film (for example, about 5 μm or more) of outer electrode produced by co-firing (firing at the same time) or other conductor layers are formed, at least, the common material blending ratio was desirably about 0.77 or more on a volume ratio basis.

Evaluation Based on Change in Solid Concentration

A dielectric layer having a forming thickness of about 1 μm was able to be produced by specifying the average particle diameter of the CaTi,ZrO₃ pigment contained in the dielectric layer ink to be about 120 nm and using a dielectric layer ink having a PVC of about 80% and a solid concentration of about 10 percent by volume. Also, a dielectric layer having a forming thickness of about 25 μm was able to be produced by specifying the average particle diameter of the CaTi,ZrO₃ pigment contained in the dielectric layer ink to be about 400 nm and using a dielectric layer ink having a PVC of about 80% and a solid concentration of about 27.0 percent by volume.

In the case where the forming thickness of about 1 μm was produced by the metal pigment ink, the average particle diameter of the Ni pigment contained in the metal pigment ink was specified to be about 300 nm, the average particle diameter of the CaZrO₃ pigment was specified to be about 13 nm, and a metal pigment ink having a PVC of about 70% and a solid concentration of about 9.0 percent by volume was used, so that a conductor layer having a forming thickness of about 1 μm was able to be produced. In the case where the forming thickness of about 25 μm was produced by the metal pigment ink, the average particle diameter of the Ni pigment contained in the metal pigment ink was specified to be about 200 nm, the average particle diameter of the CaZrO₃ pigment was specified to be about 200 nm, and a metal pigment ink having a PVC of about 70% and a solid concentration of about 20.5 percent by volume was used, so that a conductor layer having a forming thickness of about 25 μm was able to be produced.

Therefore, in the method for manufacturing a ceramic electronic component with the ink-jet system, it is desirable that the solid concentration be changed in accordance with the forming thickness, that is, it is desirable that the solid concentration be increased as the forming thickness to be produced increases. For example, in the case where the lower outer layer portion or upper outer layer portion, the outer electrode produced by co-firing (firing at the same time), and a via are formed, each layer is formed having a relatively large thickness and, therefore, the solid concentrations of the used dielectric layer ink and the metal pigment ink are specified to be desirably about 20 percent by volume. In the case where a thin formed film, such as, an inner electrode, is produced, the solid concentrations of the dielectric layer ink and the metal pigment ink to be used are specified to be desirably about 10 percent by volume.

On the other hand, if a thick film is formed by using an ink having a low solid concentration, such as, the solid concentration of about 10 percent by volume or less, it is considered that problems occur, for example, cracking occurs during drying and the cost increases because of an increase in the number of times of recoating.

The method for manufacturing a ceramic electronic component, according to an embodiment of the present invention, can also produce a formed body having a conductor circuit by appropriately combining the step to form the dielectric layer by ejecting the dielectric layer ink with the ink-jet system and the step to form the conductor layer by ejecting the metal pigment ink with the ink-jet system.

That is, the monolithic ceramic electronic component is not limited to the capacitor, and the method for manufacturing a ceramic electronic component, according to an embodiment of the present invention, can be applied to production of an inductor and can also be applied to production of a multilayer ceramic substrate having a through hole and a via hole. Also, application is not limited to the monolithic ceramic electronic component, and application to production of a single-layer ceramic substrate and the like is possible.

The present invention is not limited to the above-described embodiments and is variously modified within the scope of the gist thereof. The thickness of the ceramic layer of the ceramic electronic component, the number of layers, the counter electrode area, and the outer dimensions are not limited to those described above.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A method for manufacturing a ceramic electronic component, the method comprising:
forming a dielectric layer by ejecting a dielectric layer ink having a pigment volume concentration of 60% or more and 95% or less with an ink-jet system;
forming a first conductor layer on the dielectric layer by ejecting a first metal pigment ink having a first pigment volume concentration of 70% or more and 95% or less with the ink-jet system so as to form a body having a conductor circuit;
removing organic components of the resulting formed body by degreasing; and
sintering the dielectric layer and the first conductor layer by firing.

2. The method for manufacturing a ceramic electronic component, according to claim 1,
wherein a single piece of the formed body or a plurality of pieces of the formed body are produced at the same time.

3. The method for manufacturing a ceramic electronic component, according to claim 1,
wherein a solid concentration of the dielectric layer ink is 10 percent by volume or more and 27 percent by volume or less.

4. The method for manufacturing a ceramic electronic component, according to claim 3,
wherein a solid concentration of the first metal pigment ink is 9 percent by volume or more and 20.5 percent by volume or less.

5. The method for manufacturing a ceramic electronic component, according to claim 4,
wherein the solid concentration of the dielectric layer ink or the first metal pigment ink is increased as a forming thickness of the dielectric layer or the first conductor layer increases.

6. The method for manufacturing a ceramic electronic component, according to claim 3,
wherein the solid concentration of the dielectric layer ink is increased as a forming thickness of the dielectric layer increases.

7. The method for manufacturing a ceramic electronic component, according to claim 1,
wherein a solid concentration of the first metal pigment ink is 9 percent by volume or more and 20.5 percent by volume or less.

8. The method for manufacturing a ceramic electronic component, according to claim 7,
wherein the solid concentration of the first metal pigment ink is increased as a forming thickness of the first conductor layer increases.

9. The method for manufacturing a ceramic electronic component, according to claim 1, further comprising:
forming a second conductor layer in contact with the first conductor layer by ejecting a second metal pigment ink having a second pigment volume concentration of 70% or more and 95% or less with the ink-jet system.

10. The method for manufacturing a ceramic electronic component, according to claim 1,
wherein a speed of ejecting the dielectric layer ink and the first metal pigment ink is 6 m/s.

11. The method for manufacturing a ceramic electronic component, according to claim 1, further comprising:
drying the dielectric layer ink before forming the first metal pigment ink.
